(19) United States
(12) Patent Application Publication
(10) Pub. No.: US 2006/0147706 A1
(43) Pub. Date: Jul. 6, 2006

(54) Sizing composition for glass staple fibres, method using said composition and resulting products

(75) Inventors: Patrick Moireau, Lieu-Dit (FR); Anne Berthereau, Challes Les Eaux (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: SAINT-GOBAIN VETROTEX FRANCE S.A., Chambery (FR)

(21) Appl. No.: 10/519,848

(22) PCT Filed: Jul. 9, 2003
(86) PCT No.: PCT/FR03/02137

§ 371 Date: Aug. 15, 2005

(30) Foreign Application Priority Data
Jul. 18, 2002 (FR) 02/09368

(51) Int. Cl. C08L 91/00; D03D 15/00; C03C 17/02; D02G 3/00

(52) U.S. Cl. 428/361; 65/443; 65/447; 106/243; 139/420 C

(57) ABSTRACT

The present invention relates to a sizing composition for glass yarns, especially in the form of staple glass yarns, comprising at least one fatty acid containing at least two ethylene bonds. The invention also relates to a process for manufacturing staple glass yarns using said sizing composition and to the staple glass yarn coated with the sizing composition.

The present invention relates to the field of staple glass yarns used in the construction of fabrics, especially those intended to form wall coverings. It relates to a sizing composition or size for staple glass yarn, to the process using this composition and to the staple glass yarn obtained.

The term “staple glass yarns” is understood to mean discontinuous glass yarns obtained by fiberizing molten glass through the orifices of a bushing.

The bushing in question may be fed equally well by pieces of glass, generally in bead form (“remelting” process), or by molten glass coming from a furnace (“direct” process). The glass may be E-glass, C-glass or any other glass that can undergo the fiberizing operation.

The staple glass yarn may be in the form of a tow, improperly called a “roving”, which is a continuous twist-free assembly of approximately parallel glass yarns held together by their mutual adhesion. The roving results from the assembly of discontinuous filaments intermingled by a false twist. Generally speaking, this tow is either used as such, to form the weft of certain types of fabric, or is twisted to form a textile yarn therefrom, or is chopped into elements of specified length.

The manufacture of staple glass yarn may be carried out using the process described, for example, in patent application FR-A-2 817 548. The molten glass filaments flowing from the bushing are drawn and wound in the form of a web on a roll located more or less vertically beneath the bushing. After the roll has rotated through about 270°, the filament web comes into contact with a blade that separates it from the surface of the roll and chops the filaments, and then these filaments are directed toward an oblong device of conical shape that includes, at its center, a core yarn that moves from one end of the cone to the other. The filaments coming from the roll are wound around the core yarn and form a roving that, on leaving the cone, is wound onto a winder placed laterally to the oblong element. The core yarn gives the staple glass yarn strength when the latter is stressed in tension: it may be made of glass or better still made of plastic.

Except when they are intended to form fuzz, the filaments, before they are gathered together in the form of yarns, are coated with a sizing composition for protecting them from the abrasion that occurs when they rub against the members of the various devices used to form them.

The sizing composition is applied by means of appropriate devices, such as spray nozzles, coating rolls or brushes, generally these being placed upstream of the point where the filaments are deposited on the roll and upstream of the blade.

The roll of the size is essential. In addition to its abrasion protection function, it makes it possible for the staple glass yarn to be combined with organic and/or inorganic materials, in particular making it easier for the roving to be wetted and impregnated by these materials. The sizing composition also encourages bonding between the filaments, resulting in better dimensional stability of the yarn. Being able to have such yarns is advantageous when it is desired to use them under conditions requiring high mechanical stresses, for example for textile applications.

It is expected in particular of a size for it to promote bonding of the filaments to the drawing roll, to make it possible to obtain a sharp cut by the blade and not to form excessive “fuzz”, that is to say broken filaments that, by building up on certain members such as pulleys, prevent them from operating. Another reason for wishing to limit the amount of fuzz is that it is easily dispersed in the air that the operators are likely to breathe, something which it is desirable to avoid.

Generally speaking, the sizing compositions must also be able to withstand the shear caused by the yarns passing over the drawing devices and to wet the surface of the filaments, and to do so at high drawing rates of the order of several tens of meters per second. They must also not confer a not too pronounced “slip” character so that the bobbins of staple glass yarn retain their dimensional stability during transportation and storage, that is to say the turns do not collapse.

The compositions must also retain their initial properties over time and their constituents must remain stable before being deposited on the filaments.

The usual sizing compositions suitable for the production of staple glass yarn are essentially based on one or more mineral oils, optionally combined with surfactants. Although the oil does allow effective protective from abrasion and helps to form a roving with body (or also “bulk”), it also gives the filaments “slip”, making the roving insufficiently cohesive to allow it to be woven correctly, especially because knots form. To meet the weaving conditions, it is in fact essential for the roving to have integrity, that is to say that the filaments of which it is composed must be able as it were to catch on one another. The bonding of the filaments must remain flexible so that to a certain extent the latter remain free to move with respect to one another when large variations in tension occur, and thus avoid sudden breakage of the roving. In general, it may be considered that the greater the resistance of a roving to elongation, the better the weavability.

The search for a sizing composition having better weaving performance must not be undertaken to the detriment of the other properties. In particular, the composition must remain capable of being applied by air spray nozzles operating with a pressure of about 20 bar without generating excessively fine drops capable of forming a kind of mist. The presence of mist near the nozzles results in a loss of sizing composition, which is not deposited on the filaments, and a higher probability of the operators inhaling the products in question.

One subject of the present invention is a sizing composition that can coat glass yarns, in particular in the form of staple glass yarn, that improves their tensile strength and thus allows better weaving.

Another subject of the invention relates to sized glass yarns, particularly in the form of staple glass yarn, sized by means of the composition defined in the previous paragraph, said yarns having, because of a certain degree of elasticity, better tensile strength, which permits them to be woven at a higher speed, especially so as to form a wall covering of the paint canvas type.

The sizing composition according to the invention consists of a solution that is characterized by the fact that it contains at least one fatty acid containing at least two ethylene bonds.

In the present invention, the term “sizing composition” is understood to mean a composition that can be deposited on glass filaments and to protect them during their production, in particular so as to obtain a staple glass yarn. In general, such a composition is in the form of a solution having a viscosity of less than or equal to 120×10⁻³ Pa·s (120 cP) and it comprises at least one lubricant and optionally other additives, for example a coupling agent for coupling to the glass, a textile processing aid or a surfactant. In the context of the invention, the sizing composition is substantially free of water, that is to say that it contains less than 5%, preferably less than 1%, water and better still contains no water. On the other hand, the composition may contain one or more organic solvents that can be used to dissolve all or part of the components used in the sizing composition.

The fatty acid is chosen from unsaturated fatty acids containing 10 to 24 carbon atoms, preferably 14 to 22 carbon atoms. Linear-chain fatty acids are preferred.

Advantageously, the unsaturated fatty acids satisfy the following general formula:

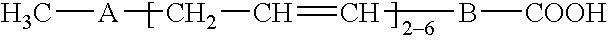

in which A and B represent a hydrocarbon chain and the total number of carbon atoms in the chains A and B varies from 2 to 16.

Particularly preferred fatty acids contain 18 to 22 carbon atoms and satisfy the above formula in which:

A=—(CH₂)ₓ—, x being an integer varying from 0 to 6, preferably equal to 0.3 or 6;

B=—(CH₂)_{y}—, y being an integer varying from 2 to 11.

As examples, mention may be made of: linoleic acid (cis,cis-9,12-octadecadienoic acid), linolelaidic acid (trans,trans-9,12-octadecadienoic acid), γ-linolenic acid (6,9,12-octadecatrienoic acid), linolenic acid (trans,trans,trans-9,12,15-octadecatrienoic acid), α-eleostearic acid (cis, trans, trans-9, 12,15-octadecatrienoic acid), β-eleostearic acid (trans,trans,trans-9,12,15-octadecatrienoic acid), cis,cis-11,14-eicosadienoic acid, cis, cis, cis-5,8,11-eicosatrienoic acid, cis,cis,cis-8,11 acid, 14-eicosatrienoic acid, cis,cis,cis-11,14,17-eicosatrienoic acid, cis,cis,cis,cis-5,8, 11,14,17-eicosapentaenoic acid, arachidonic acid (5,8,11,14-eicosatetraenoic acid), cis,cis-13,16-docosadienoic acid, cis,cis,cis-13,16,19-docosatrienoic acid, cis,cis,cis,cis-7,10,13,16-docosa-tetraenoic acid, clupanodonic acid (4,8,12,15,19-docosapentaenoic acid) cis,cis,cis,cis,cis-7,10,13,16,19-docosapentaenoic acid, cis,cis,cis,cis,cis,cis-4,7,10,13,16,19-docosahexaenoic acid and mixtures of these compounds. As examples of such mixtures, mention may be made of natural fatty acids, particularly linoleic acid and linolenic acid. Linoleic acid is preferred.

Without being tied to any explanation, it is believed that the double bonds of the fatty acid react with oxygen from the air and form products of higher molecular mass provided with adhesive properties that allow the filaments to adhere together and therefore give the roving cohesion.

In general, the unsaturated fatty acid content in the sizing composition is greater than or equal to 5%, preferably greater than or equal to 8%. Advantageously, it does not exclude 60%, preferably 40%, by weight. More particularly preferably, the fatty acid content is between 10 and 30%.

According to one embodiment of the invention, the sizing composition furthermore comprises at least one polymer carrying one or more hydroxyl, epoxy and/or amine reactive functional groups, and more particularly having a molecular mass of at least 300 and preferably less than 3000.

Preferably, the aforementioned polymers also contain one or more double bonds. The presence of unsaturated groups provides the elastomeric character that allows the staple glass yarn to have a certain elasticity and therefore have a better tensile strength.

Advantageously, polymers containing one or more hydroxyl or epoxy reactive functional groups, preferably in terminal positions, for example the hydroxyl-terminated PolyBd® sold by Atofina, and polymers containing one or more amine reactive functional groups, preferably in terminal positions, for example diamine PolyB® sold by Atofina, are used. However, it should be noted that the latter polymer gives the staple glass yarn a slight yellow coloration and that it also requires more delicate handling as it is more sensitive to the carbon dioxide in the air than the other polymers.

According to the invention, the content of the aforementioned polymer may represent up to 40% by weight of the sizing composition, and preferably it varies from 5 to 30% and even better from 8 to 25%.

According to the preferred embodiment of the invention, the sizing composition comprises the combination of linoleic acid and polybutadiene containing hydroxyl reactive functional groups, preferably in terminal positions. This combination makes it possible to obtain particularly beneficial results; it makes it possible in particular to substantially increase the tenacity of the staple glass yarn, this increase taking place during storage of the wound packages, without a drying step, as will be explained later.

In addition to the aforementioned compounds, the sizing composition may include one or more components (hereinafter denoted by additives) that give the sizing composition particular properties.

The composition according to the invention may also include a solvent whose role is to adapt the viscosity to the application conditions. This solvent does not react with the constituents in the sizing composition nor does it have the function of dissolving them either. As an example, mention may be made of NMP (1-methyl-2-pyrrolidinone) and methyl or ethyl diesters of adipic acid or succinic acid. The aforementioned esters are preferred, especially because they can “wet” the glass well, without having a deleterious effect.

The amount of solvent that can be used may represent up to 30% by weight of the sizing composition. However, it is preferred to limit the solvent content so as to avoid the risk of varying the concentration of the various constituents of the sizing composition due to evaporation induced by the high temperature needed to produce the glass filaments. The presence of a small amount of solvent(s) does not require a particular treatment to remove them.

The sizing composition may also include, as additive, a coupling agent for attaching the sizing composition to the glass.

The coupling agent is generally chosen from silanes, such as α-glycidoxypropyltrimethoxysilane, α-acryloxypropyltrimethoxysilane, ie α-methacryloxypropyltrimethoxysilane, poly(oxyethylene/oxypropylene)trimethoxysilane, α-aminopropyltriethoxysilane, vinyltrimethoxysilane, phenylaminopropyltrimethoxysilane, styrylaminoethylaminopropyl-trimethoxysilane or tert-butylcarbamoylpropyltrimethoxysilane, siloxanes, titanates, zirconates and mixtures of these compounds. Preferably, silanes are chosen.

The proportion of coupling agent(s) is generally between 0 and 20%, preferably between 0 and 15%, by weight of the sizing composition. In general, the sizing composition contains no coupling agent.

The composition may also include, as additive, at least one textile processing aid acting essentially as a lubricant and/or surfactant, and it is in many cases necessary for the composition to have the functions of a size.

The proportion of textile processing aid is generally between 0 and 40%, preferably 5 and 25%, by weight of the composition.

The textile processing aid is generally chosen from fatty esters such as decyl laurate, isopropyl palmitate, cetyl palmitate, isopropyl stearate, isobutyl stearate, trimethylolpropane trioctanoate and mixtures based on mineral oils.

As examples of surfactants, mention may be made of ethylene glycol adipate, alkylphenol derivatives, such as ethoxylated nonylphenol, and glycol derivatives, such as polyethylene glycols or polypropylene glycols of molecular mass less than 2000.

The composition according to the invention is generally deposited on glass filaments in a single step, for example under the conditions of the process described in FR-A-2 817 548. In this process, the sizing composition is applied to the filaments immediately before they come into contact with the roll, and possibly also afterwards. The application may be performed in various ways, the most common being spraying by means of a nozzle or more generally two nozzles moving in opposite directions one with respect to the other along the generatrix of the roll so as to obtain a uniform distribution over the entire web. In general, it is preferable to use a sizing composition having a viscosity of less than or equal to 120×10⁻³ Pa·s (120 cP), and advantageously between 50 and 100×10⁻³ Pa·s (50 and 100 cP). When the application is performed by spraying, it is recommended to have a viscosity of around 60 to 100×10⁻³ Pa·s (60 to 100 cP). However, a high viscosity is not unacceptable, spraying remaining possible if air is introduced into the nozzle with a higher flow rate.

The sized filaments are separated from the roll and chopped by the blade, and then they form a roving that is either collected in the form of packages by means of rotating supports, for example castors, or deposited on a support that moves translationally, in order to form a web or mat, or chopped into segments of appropriate length.

The staple glass yarn obtained according to the invention may thus be in various forms after being collected, for example in the form of bobbins of tows, assembled rovings or braids, mats or chopped yarns.

The staple glass yarn coated with the sizing composition exhibits good unwindability and can be easily handled, the filaments remaining perfectly cohesive. In particular, straight-sided packages retain their dimensional characteristics and are not deformed.

As a general rule, the staple glass yarn is coated with an amount of size such that it has a loss on ignition of less than 2%, preferably less than 1% and better still less than 0.85%. Preferably, the loss on ignition is greater than 0.3% and advantageously greater than 0.6%.

The glass filaments constituting the staple glass yarn have a diameter that may vary widely, usually from 5 to 30, preferably from 6 to 14 μm. They may be made of any glass, the most common in the field being E-glass and C-glass.

The packages obtained are then placed on pallets to be shipped to the various locations where the staple glass yarn is woven, especially to make wall coverings, for example paint canvas, therefrom. The sizing composition according to the invention requires no predrying of the packages before they are sent on for packaging. Avoiding passage through an oven makes it possible both to reduce energy consumption and to limit handling of the packages, and consequently to reduce the production cost.

To produce paint canvas, bobbins of staple glass yarn are placed on weaving machines that generally operate at high rate, around 450 to 470 insertions/minute. With the staple glass yarn coated with the sizing according to the invention, it is possible to use air jet looms that operate at high speed (500 to 550 insertions/minute or more) and therefore to increase the productivity while maintaining a relatively low number of “breaks”. Furthermore, the staple glass yarn has improved bulk, giving it better “covering” power and making it possible to obtain a homogeneous fabric (with no “holes”).

The staple glass yarn generally has a tenacity of greater than 4 cN/tex, preferably greater than 7.5 cN/tex, thus making it possible to form fabrics that are very resistant to painting treatments.

After weaving, the cloth is coated with a “finish” intended to give it sufficient strength to allow it to be laid on the final backing. The finish is generally a starch solution or an acrylic or PVA emulsion that is applied to the cloth by impregnation in a bath. There must be very good compatibility between the size and the finish so that the cloth retains its properties until it is finally used. The staple glass yarn according to the invention has a very high level of compatibility with the finish, especially because the sizing composition is able to contain a large amount of surfactants (up to 40% by weight).

The examples that follow allow the invention to be illustrated without however limiting it.

In these examples, the following methods are used for measuring the physical and mechanical properties of the staple glass yarn coated with the sizing composition according to the invention:
the viscosity is measured on a Brookfield RVT M2 instrument at 20±2° C. and is expressed in Pa·s;
the surface tension is measured using an M3 blade tension meter sold by Prolabo. It is expressed in mN/m;
the tenacity is determined by measuring the tensile strength under the following conditions. A device consisting of two pulleys, a tensile testing machine and a pull wire connected to a motor are used. The upper pulley (diameter: 205 mm) and the lower pulley of smaller diameter are 355 mm apart, the pulleys being placed vertically. The lower pulley is connected to a tensile testing machine that is itself connected to the pull wire driven by the motor (speed: 350 mm/min). The staple glass yarn is wound twice around the pulleys and the motor is switched on. The tenacity measurement corresponds to the value measured on the tensile testing machine when the staple glass yarn breaks. The tenacity is expressed in cN/tex;
the loss on ignition is measured according to the ISO 1887 standard and is expressed in % by weight.

### EXAMPLE 1

### Comparative

A staple glass yarn, consisting of 400 C-glass filaments 11 μm in diameter, was formed using the device described in FR-A-2 817 548. A sizing composition comprising a mixture of mineral oils and surfactants⁽¹⁾ having a viscosity of 80×10⁻³ Pa·s (80 cP) and a surface tension of 31.4 mN/m was sprayed onto the filaments immediately after they came into contact with the roll.

The web of filaments was separated from the roll and the chopped filaments were gathered into a stable glass yarn to form a bobbin.

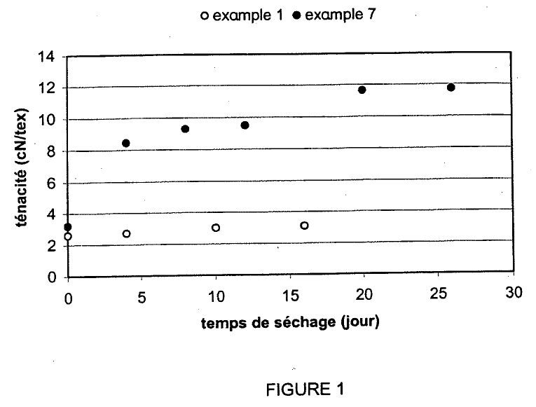

The change in the tenacity of the staple glass yarn unwound from the bobbin as a function of time is given in FIG. 1. The tenacity was 2.6 cN/tex initially and was 3 cN/tex after 10 days.

The loss on ignition was 0.5%.

### EXAMPLE 2

The procedure was as in example 1, the sizing composition comprising (in percent by weight):

| | |
|---|---|
| mixture of mineral oils and of surfactants⁽¹⁾ | 42 |
| linoleic acid | 42 |
| ethoxylated (4 EO) lauric alcohol⁽²⁾ | 16 |

The viscosity of the composition was 70×10⁻³ Pa·s (70 cP).

The staple glass yarn unwound from the bobbin had a tenacity of 2.6 cN/tex initially and 3.9 cN/tex after 10 days.

### EXAMPLE 3

The procedure was as in example 1, the sizing composition comprising (in percent by weight):

| | |
|---|---|
| linoleic acid | 60 |
| isopropyl palmitate | 40 |

The viscosity of the composition was 44×10⁻³ Pa·s (44 cP).

The staple glass yarn unwound from the bobbin had a tenacity of 2.7 cN/tex and 5.4 cN/tex after 10 days.

### EXAMPLE 4

The procedure was as in example 1, the sizing composition comprising (in percent by weight):

| | |
|---|---|
| mixture of mineral oils and of surfactants⁽¹⁾ | 15 |
| linoleic acid | 20 |
| isopropyl palmitate | 15 |
| aromatic polyurethane hexaacrylate | 20 |
| (molecular mass: 1000)⁽³⁾ | |
| ethoxylated (4 EO) lauric alcohol⁽²⁾ | 15 |
| NMP | 15 |

The viscosity of the composition was 105×10⁻³ Pa·s (105 cP).

The staple glass yarn unwound from the bobbin had a tenacity of 2.7 cN/tex initially and 8.1 cN/tex after 10 days.

### EXAMPLE 5

The procedure was as in example 1, the sizing composition comprising (in percent by weight):

| | |
|---|---|
| linoleic acid | 25 |
| hydroxyl-terminated polybutadiene⁽⁴⁾ | 25 |
| (molecular mass: 2800) | |
| isopropyl palmitate | 12.5 |
| ethoxylated (4 EO) lauric alcohol⁽²⁾ | 12.5 |
| NMP | 25 |

The viscosity of the composition was 120×10⁻³ Pa·s (120 cP) and a surface tension of 34.7 mN/m.

The staple glass yarn unwound from the bobbin had a tenacity of 1.6 cN/tex initially and 7.5 cN/tex after 10 days, and a loss on ignition of 0.72%.

### EXAMPLE 6

The procedure was as in example 1, the sizing composition comprising (in percent by weight):

| | |
|---|---|
| linoleic acid | 25 |
| hydroxyl-terminated polybutadiene⁽⁵⁾ | 20 |
| (molecular mass: 1220) | |
| isopropyl palmitate | 15 |
| ethoxylated (4 EO) lauric alcohol⁽²⁾ | 15 |
| mixture of methyl esters of adipic, | 25 |
| succinic and glutaric acids⁽⁶⁾ | |

The viscosity of the composition was 64×10⁻³ Pa·s (64 cP) and a surface tension of 32.8 mN/m.

The staple glass yarn unwound from the bobbin had a tenacity of 2.5 cN/tex initially and 8.0 cN/tex after 10 days, and a loss on ignition of 0.4%.

### EXAMPLE 7

The procedure was as in example 1, the sizing composition comprising (in percent by weight):

| | |
|---|---|
| linoleic acid | 20 |
| hydroxyl-terminated polybutadiene⁽⁵⁾ | 20 |
| (molecular mass: 1220) | |
| mineral-oil-based textile processing aid⁽⁷⁾ | 20 |
| ethoxylated (4 EO) lauric alcohol⁽²⁾ | 15 |
| mixture of methyl esters of adipic, | 25 |
| succinic and glutaric acids⁽⁶⁾ | |

The viscosity of the composition was 68×10⁻³ Pa·s (68 cP) and a surface tension of 32.5 mN/m.

The change in the tenacity of the staple glass yarn unwound from the bobbin as a function of storage time, without prior drying, is given in FIG. 1. The tenacity was 3.2 cN/tex initially and 9.5 cN/tex after 10 days, and a loss on ignition of 0.6%.

### EXAMPLE 8

The procedure was as in example 1, the sizing composition comprising (in percent by weight):

| | |
|---|---|
| linoleic acid | 20 |
| hydroxyl-terminated polybutadiene⁽⁵⁾ | 20 |
| (molecular mass: 1220) | |
| 2,2,4-trimethyl-1,3-pentanediol monoisobutyrate⁽⁸⁾ | 20 |
| ethoxylated (4 EO) lauric alcohol⁽²⁾ | 15 |
| mixture of methyl esters of adipic, | 25 |
| succinic and glutaric acids⁽⁶⁾²⁵ | |

The viscosity of the composition was 68×10⁻³ Pa·s (68 cP) and a surface tension of 32.7 mN/m.

The staple glass yarn unwound from the bobbin had a tenacity of 3.1 cN/tex initially and 9.2 cN/tex after 10 days, and a loss on ignition of 0.81%.

### EXAMPLE 9

The procedure was as in example 1, the sizing composition comprising (in percent by weight):

| | |
|---|---|
| linoleic acid | 12.5 |
| hydroxyl-terminated polybutadiene⁽⁵⁾ | 20 |
| (molecular mass: 1220) | |
| 2,2,4-trimethyl-1,3-pentanediol monoisobutyrate⁽⁸⁾ | 27.5 |
| ethoxylated (4 EO) lauric alcohol⁽²⁾ | 15 |
| mixture of methyl esters of adipic, | 25 |
| succinic and glutaric acids⁽⁶⁾ | |

The viscosity of the composition was 62×10⁻³ Pa·s (62 cP) and a surface tension of 32.2 mN/m.

The staple glass yarn unwound from the bobbin had a tenacity of 3.2 cN/tex initially and 8.5 cN/tex after 10 days, and a loss on ignition of 0.25%.

### EXAMPLE 10

The procedure was as in example 1, the sizing composition comprising (in percent by weight):

| | |
|---|---|
| linoleic acid | 20 |
| hydroxyl-terminated polybutadiene⁽⁵⁾ | 18 |
| (molecular mass: 1220) | |
| 2,2,4-trimethyl-1,3-pentanediol monoisobutyrate⁽⁸⁾ | 17 |
| ethoxylated (4 EO) lauric alcohol⁽²⁾ | 15 |
| mixture of methyl esters of adipic, | 25 |
| succinic and glutaric acids⁽⁶⁾ | |
| φ-methacryloxypropyltriméthoxysilane⁽⁹⁾ | 7 |
| φ-glycidoxypropyltriméthoxysilane⁽¹⁰⁾ | 3 |

The viscosity of the composition was 59×10⁻³ Pa·s (59 cP) and a surface tension of 32.7 mN/m.

The staple glass yarn unwound from the bobbin had a tenacity of 2.7 cN/tex initially and 10.0 cN/tex after 10 days, and a loss on ignition of 0.65%.

The above examples show that the addition of unsaturated fatty acid has the effect of improving the tenacity of the staple glass yarn, this effect being attributed to the conversion of the ethylene bonds. Although the initial tenacity, measured immediately after winding the staple glass yarn, remains similar to that obtained with a control size (example 1) of around 3 cN/tex, it does, however, change over time. After 10 days, the increase in tenacity varies from 50% (example 2) to 200% (example 4), while it remains low for the control size (13% in the case of example 1).

Examples 5 to 10 show that the effect of the unsaturated fatty acid is enhanced when a hydroxyl-terminated polymer is added. A tenacity value more than three times higher than that of the size of example 1 is obtained in particular in examples 7, 8 and 10. Furthermore, it is worthwhile pointing out that the polymer contributes to making the sizing composition more stable. This effect is visible in particular in the case of the composition of example 4 which, although giving the staple glass yarn a good level of tensile strength, is unstable and has to be rapidly processed. In comparison, the composition of examples 7, 8 and 10, that combine the same unsaturated fatty acid content and a polymer, remains stable, with furthermore an increased tenacity.

The increase in tenacity obtained with the sizing composition according to the invention does not occur to the detriment of the other properties, that is to say the surface tension and the viscosity, both these being comparable to those of the control composition.

Moreover, it has been found that the sizing composition according to the invention can be sprayed without generating a mist and that the staple glass yarn obtained can be easily handled: it is easily paid out and has an improved toughness for a relatively low loss on ignition, i.e. less than 0.85%.

| | |
|---|---|
| (1) sold under the reference “SMOTILON VS 12” | by Goldschmidt |
| (2) sold under the reference “SIMULSOL P4” | by Seppic |
| (3) sold under the reference “EBECRYL 220” | by Union |
| | Chimique Belge |
| (4) sold under the reference “PolyBd R 45 HT” | by Atofina |
| (5) sold under the reference “PolyBd R 20 LM” | by Atofina |
| (6) sold under the reference “Dibasic Ester” | by DuPont |
| (7) sold under the reference “TORFIL LA 4” | by Lamberti |
| (8) sold under the reference “TEXANOL” | by Eastman |
| (9) sold under the reference “SILQUEST Si A 174” | by Witco OSI |
| (10) sold under the reference “SILQUEST Si A 187” | by Witco OSI |

1. A glass yarn, coated with a sizing composition consisting of a solution comprising at least one fatty acid containing at least two ethylene bonds.

2. The glass yarn as claimed in claim 1, wherein the fatty acid contains 10 to 24, preferably 14 to 22, carbon atoms.

3. The glass yarn as claimed in claim 1 wherein the fatty acid is chosen from linear-chain fatty acids.

4. The glass yarn as claimed in claim 3, wherein the fatty acid satisfies the following formula: 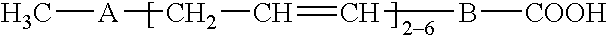
in which A and B represent a hydrocarbon chain and the total number of carbon atoms in the chains A and B varies from 2 to 16.

5. The glass yarn as claimed in claim 4, wherein the acid contains 18 to 22 carbon atoms and satisfies the above formula wherein:
A=—(CH₂)ₙ— x being an integer varying from 0 to 6, preferably equal to 0.3 or 6,
B=—(CH₂)_{y}— y being an integer varying from 2 to 11.

6. The glass yarn as claimed in claim 1, wherein the composition furthermore comprises at least one polymer carrying one or more hydroxyl, epoxy and/or amine reactive functional groups.

7. The glass yarn as claimed in claim 6, wherein the polymer has a molecular mass of at least 300.

8. The glass yarn as claimed in claim 6 wherein the polymer is a hydroxyl-terminated or amine-terminated polybutadiene.

9. The glass yarn as claimed in claim 1 wherein the fatty acid content is greater than or equal to 5%, preferably greater than or equal to 8%, by weight of the composition.

10. The glass yarn as claimed in claim 6 wherein the polymer content represents up to 40%, preferably 5 to 30% and advantageously 8 to 25%, by weight of the composition.

11. The glass yarn as claimed in claim 1 wherein the sizing composition further comprises at least one solvent in a proportion of between 0 and 30% by weight of the composition.

12. The glass yarn as claimed in claim 1 wherein the sizing composition further comprises at least one coupling agent in a proportion of between 0 and 20% by weight.

13. The glass yarn as claimed in claim 1 wherein the sizing composition comprises at least one textile processing aid in a proportion from 0 to 40%.

14. A sizing composition for glass yarn, in particular a staple glass yarn, consisting of a solution containing less than 5% water and comprising at least one fatty acid containing at least two ethylene bonds.

15. The sizing composition as claimed in claim 14, wherein the sizing composition has a viscosity of less than 120×10⁻³ Pa·s, preferably between 50 and 100×10⁻³ Pa·s.

16. The sizing composition as claimed in claim 14 wherein the fatty acid content is greater than or equal to 5%, preferably greater than or equal to 8%, by weight of the composition.

17. The sizing composition as claimed in claim 14 wherein the sizing composition further comprises at least one polymer carrying one or more hydroxyl, epoxy and/or amine reactive functional groups.

18. The sizing composition as claimed in claim 17, wherein the sizing composition includes a mixture of linoleic acid and of hydroxyl-terminated polybutadiene.

19. A process for manufacturing sized glass yarns, especially sized staple glass yarns, in which a mass of molten glass streams flowing from a mass of orifices are drawn and wound in the form of a web on a rotating roll located more or less vertically beneath the bushing, the web is separated from the roll and the filaments chopped by means of a blade and said filaments are gathered together to form a staple glass yarn, said process consisting of depositing a sizing composition as claimed in claim 14 on the surface of the filaments before they come into contact with the roll.

20. The process as claimed in claim 19, wherein the sizing composition is deposited by spraying.

21. A method of forming a fabric, comprising utilizing the glass yarn as claimed in claim 1.

22. A glass fabric comprising the glass yarn, as claimed in claim 1 wherein said glass yarn is a staple glass yarn and wherein said staple glass yarn has a tenacity of greater than 4 cN/tex, preferably greater than 7.5 cN/tex.

23. The glass yarn as claimed in claim 1 wherein the glass yarn is a staple glass yarn.

24. The glass yarn as claimed in claim 6 wherein the polymer has a molecular mass of at least 300 and less than 3000.

25. The method as claimed in claim 21, wherein said fabric is a paint canvas.

26. A paint canvas comprising a fabric prepared by the method as claimed in claim 25.
